(19) United States
(12) Patent Application Publication
(10) Pub. No.: US 2026/0284709 A1
(43) Pub. Date: Sep. 24, 2026

(54) MEASUREMENT APPARATUS AND SORTER

(71) Applicant: SATAKE Corporation, Tokyo (JP)

(72) Inventors: Hideaki ISHIZU, Tokyo (JP); Tomoyuki MIYAMOTO, Tokyo (JP)

(73) Assignee: SATAKE Corporation, Tokyo (JP)

(21) Appl. No.: 19/132,221

(22) PCT Filed: Aug. 21, 2023
(86) PCT No.: PCT/JP2023/029975

§ 371 Date: May 22, 2025

(30) Foreign Application Priority Data
Nov. 25, 2022 (JP) 2022-188537

(51) Int. Cl. B07C 5/342; G01N 21/89

(52) U.S. Cl. CPC B07C 5/342; G01N 21/89

(57) ABSTRACT

A measurement apparatus for measuring a feature about shape and/or dimension with respect to a whole and/or part of a target includes a conveyance part, an electromagnetic wave irradiation source, a line sensor including a plurality of electromagnetic wave detection elements linearly arranged in a first direction intersecting with a conveyance direction of the target, and configured to detect at least one of a reflected electromagnetic wave emitted from the electromagnetic wave irradiation source and reflected on the target and a transmitted electromagnetic wave emitted from the electromagnetic wave irradiation source and transmitted through the target, a conveyance velocity detection part configured to detect a conveyance velocity in a predetermined direction with respect to the target in transit, and a feature determination part configured to determine the feature of the target based on an image acquired by the line sensor and the conveyance velocity in the predetermined direction.

### TECHNICAL FIELD

The present disclosure relates to a technique for measuring a feature about shape and/or dimension with respect to a whole and/or part of a target.

### BACKGROUND

Conventionally, there have been known optical sorters (hereinafter also simply referred to as sorters) configured to, using light information acquired by an optical sensor when a sorting target (hereinafter also simply referred to as a target) is irradiated with light from a light source while being conveyed, determine a feature of the target (for example, whether the target is an acceptable product or a defective product) and remove a specific target (for example, a defective product). For example, Japanese Patent Application Laid-Open No. 2000-197855 discloses a sorter that uses a line sensor including a plurality of light-receiving elements linearly arranged in a direction intersecting with a conveyance direction of a target as the optical sensor. According to the line sensor, the light from the light source can be received by each light-receiving element with even illuminance, which allows a defect of the sorting target in appearance to be accurately detected.

### SUMMARY OF INVENTION

### Technical Problem

However, the sorter including the line sensor leaves room for improvement in terms of the accuracy of detecting the feature for the purpose of detecting a feature about shape and/or dimension. More specifically, the line sensor combines a plurality of linear images acquired by scanning one target again and again while the target is conveyed to acquire an image of this one target, thereby being affected by a conveyance velocity and/or a conveyance direction of the target.

For example, the line sensor has such a characteristic that, according to the conveyance velocity of the target in a direction orthogonal to the direction in which the plurality of light-receiving elements thereof is arranged (hereinafter also referred to as an arrangement direction), the resolution in this direction varies. Therefore, this characteristic leads to a reduction in the accuracy of detecting the dimension and the shape of the target in the acquired image under a processing condition that fails to maintain a constant conveyance velocity among targets.

Further, the sorter can be prone to occurrence of such a phenomenon that the conveyance direction of the target accidentally contains a component in the arrangement direction due to, for example, a collision between targets that are being conveyed. When such a phenomenon occurs, simply combining the plurality of linear images acquired by the line sensor results in undesirable detection of a shape distorted in the arrangement direction compared with the actual shape of the target. This leads to a reduction in the accuracy of detecting the shape of the target in the acquired image.

The above-described problems are not limited to sorters of types that irradiate a target with light, and are also applied in common to various sorters equipped with an electromagnetic wave irradiation source and a line sensor for detecting an electromagnetic wave. Further, these problems are not limited to sorters, and are also applied in common to measurement apparatuses for measuring a feature about shape and/or dimension of a target. Under these circumstances, the measurement apparatuses and the sorters equipped with the line sensor have faced a demand for improving the accuracy of detecting the feature about shape and/or dimension of the target.

### Solution to Problem

The present disclosure has been made to solve at least a part of the above-described problems, and can be realized in, for example, the following aspects.

According to a first aspect of the present disclosure, a measurement apparatus for measuring a feature about shape and/or dimension with respect to a whole and/or part of a target is provided. This measurement apparatus includes a conveyance part configured to convey the target, an electromagnetic wave irradiation source configured to irradiate the target with an electromagnetic wave while the target is conveyed due to an action of the conveyance part, a line sensor including a plurality of electromagnetic wave detection elements linearly arranged in a first direction intersecting with a conveyance direction of the target, and configured to detect at least one of a reflected electromagnetic wave emitted from the electromagnetic wave irradiation source and reflected on the target and a transmitted electromagnetic wave emitted from the electromagnetic wave irradiation source and transmitted through the target, a conveyance velocity detection part configured to detect a conveyance velocity in a predetermined direction with respect to the target in transit, and a feature determination part configured to determine the feature of the target based on an image acquired by the line sensor and the conveyance velocity in the predetermined direction.

“While the target is conveyed due to an action of the conveyance part” includes, for example, while the target is conveyed on the conveyance part and while the target is falling from the conveyance part. Further, the electromagnetic wave irradiation source may emit at least one of visible light, near-infrared light, and an X-ray.

According to this measurement apparatus, the feature determination part determines the feature of the target based on the image acquired by the line sensor and the conveyance velocity in the predetermined direction with respect to the target in transit. Therefore, the feature determination part can accurately determine the feature about shape and/or dimension of the target by reflecting a difference in the conveyance velocity of the target in the predetermined direction (i.e., reducing or removing an influence exerted on the image by a difference in the conveyance velocity in the predetermined direction).

According to a second aspect of the present disclosure, in the first aspect, the feature includes a first feature quantity with respect to the whole and/or part of the target. The feature determination part is further configured to correct the image acquired by the line sensor based on the conveyance velocity in the predetermined direction and determine the first feature quantity based on the corrected image, or configured to determine the first feature quantity by correcting, based on the conveyance velocity in the predetermined direction, a second feature quantity which is determined based on the image acquired by the line sensor. According to this aspect, the feature determination part can accurately determine the first feature quantity with respect to the whole and/or part of the target by correcting the image or the second feature quantity based on the conveyance velocity in the predetermined direction (i.e., by making a correction of reducing or removing an influence exerted on the image by a difference in the conveyance velocity in the predetermined direction). The first feature quantity may be, for example, at least one of an area, a height, a width, a perimeter length, and a degree of circularity of the whole and/or part of the target. The same also applies to a third aspect, which will be described below.

According to a third aspect of the present disclosure, in the first or second aspect, the feature includes a quality with respect to the whole and/or part of the target. The feature determination part is configured to determine the quality based on the first feature quantity with respect to the whole and/or part of the target. The feature determination part is further configured to correct the image acquired by the line sensor based on the conveyance velocity in the predetermined direction and acquire the first feature quantity based on the corrected image, or configured to acquire the first feature quantity by correcting, based on the conveyance velocity in the predetermined direction, a second feature quantity which is determined based on the image acquired by the line sensor. According to this aspect, the feature determination part can accurately determine the quality with respect to the whole and/or part of the target by correcting the image or the second feature quantity based on the conveyance velocity in the predetermined direction (i.e., by making a correction of reducing or removing an influence exerted on the image by a difference in the conveyance velocity in the predetermined direction). The quality may be, for example, either an acceptable/defective-product determination result (a result of a determination about whether the target is an acceptable product or a defective product) or a quality grade, based on a predetermined standard. Further, the quality may include the type of the defective product.

According to a fourth aspect of the present disclosure, in the first or second aspect, the predetermined direction includes a second direction orthogonal to the first direction. The feature includes a quality with respect to the whole and/or part of the target. The feature determination part is further configured to determine the quality by comparing a feature quantity determined based on the image acquired by the line sensor and a threshold value determined based on the conveyance velocity in the second direction. According to this aspect, the feature determination part can accurately determine the quality with respect to the whole and/or part of the target by determining the threshold value based on the conveyance velocity in the second direction (i.e., according to a change in the image dimension in the second direction due to a fluctuation of the conveyance velocity in the second direction, correcting the threshold value so as to increase/reduce the threshold value in the same direction as the change in the image dimension).

According to a fifth aspect of the present disclosure, in the second or third aspect, the predetermined direction includes a second direction orthogonal to the first direction. The feature determination part is further configured to correct the image by correcting a size of the image in the second direction based on the conveyance velocity in the second direction, or correct the second feature quantity by correcting, based on the conveyance velocity in the second direction, a feature quantity component in the second direction that is contained in the second feature quantity. According to this aspect, even when the resolution of the line sensor in the second direction varies due to a difference in the conveyance velocity of the target in the second direction, the feature determination part can correct the image or the second feature quantity so as to reduce or remove an influence of this variation in the resolution. Therefore, the feature determination part can accurately determine the feature about shape and/or dimension of the target based on the corrected image or the corrected second feature quantity.

According to a sixth aspect of the present disclosure, in any of the first to fifth aspects, the predetermined direction includes the first direction. The feature determination part is further configured to correct the image by correcting, based on the conveyance velocity in the first direction, coordinate values in the first direction at a plurality of pixels forming the image, and determine the feature of the target based on the corrected image. According to this aspect, when the conveyance velocity of the target contains a velocity component in the first direction, i.e., the target is conveyed while deviating sideways from the intended conveyance direction, the image can be corrected so as to reduce or remove a distortion of the target in the image that is caused by the sideways deviation. Therefore, the feature determination part can accurately determine the feature about shape and/or dimension of the target 90 based on the corrected image.

According to a seventh aspect of the present disclosure, a sorter is provided. The sorter includes the measurement apparatus according to any of the first to sixth aspects, and a sorting part configured to sort the target based on the feature determined by the feature determination part. According to this sorter, a similar advantageous effect to any of the first to sixth aspects can be achieved.

### BRIEF DESCRIPTION OF THE DRAWINGS

FIG. 1 is a schematic view illustrating an overview of the configuration of an optical sorter according to one embodiment of the present disclosure.

FIG. 2 is a schematic view illustrating the layout of optical elements in a color sensor.

FIG. 3 illustrates an example of a region imaged by scanning one sorting target once.

FIG. 4 illustrates one example of a method for calculating a color shift amount.

FIG. 5 illustrates an example of a method for correcting an image based on a conveyance velocity of the target in a second direction.

FIG. 6 illustrates an example of a method for correcting the image based on a conveyance velocity of the target in a first direction.

FIG. 7 illustrates the example of the method for correcting the image based on the conveyance velocity of the target in the first direction.

### DETAILED DESCRIPTION OF THE EMBODIMENTS

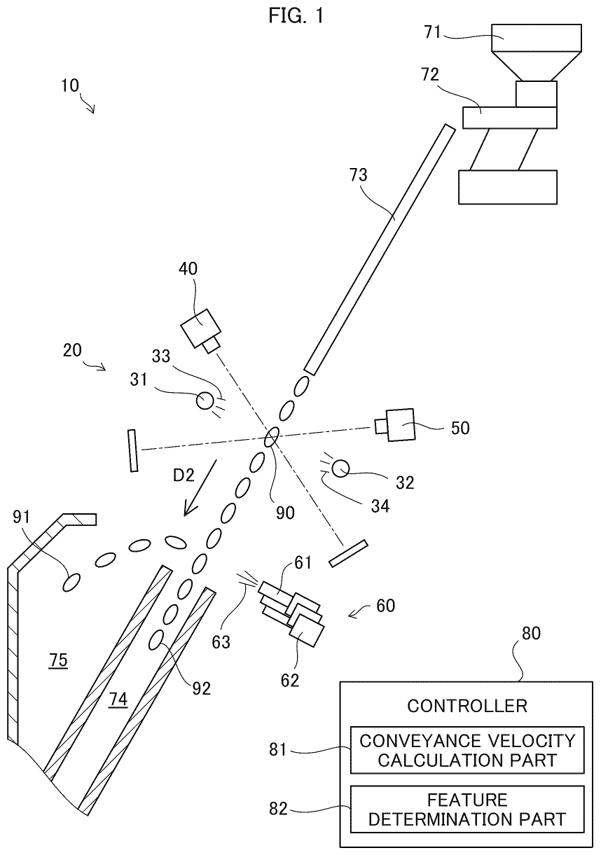

FIG. 1 is a schematic view illustrating an overview of the configuration of an optical sorter (hereinafter simply referred to as a sorter) 10 as one embodiment of the present disclosure. In the present embodiment, the sorter 10 is used to sort a defective product (for example, broken rice, an immature grain, a colored grain, a damaged grain, dead rice, and a foreign object (for example, a small stone, mud, and a glass piece)) from a rice grain (more specifically, brown rice or milled rice), which is one example of a sorting target (hereinafter simply referred to as a target) 90. However, the target 90 is not limited to brown rice or milled rice, and may be any granular object. For example, the target 90 may be unhulled rice, a wheat grain, a bean (a soybean, a chickpea, a green soybean, or the like), resin (a pellet or the like), a rubber piece, or the like.

As illustrated in FIG. 1, the sorter 10 includes an optical detection part 20, a storage tank 71, a feeder 72, a chute 73, an acceptable product discharge gutter 74, a defective product discharge gutter 75, a sorting part 60, and a controller 80. The controller 80 controls the overall operation of the sorter 10. The controller 80 also functions as a conveyance velocity calculation part 81 and a feature determination part 82. The functions of the controller 80 may be realized by a CPU executing a predetermined program, may be realized by a dedicated circuit (for example, a PLD or an ASIC), or may be realized by a combination of a CPU and a dedicated circuit. Further, the functions of the controller 80 may be assigned to a single integrated device or may be divided and assigned to a plurality of devices. The details of the functions of the controller 80 will be described below.

The storage tank 71 temporarily stores the target 90 therein. The feeder 72 feeds the target 90 stored in the storage tank 71 onto the chute 73, which is one example of a conveyance part for conveying the target. The target 90 fed onto the chute 73 slides on the chute 73 downward, and falls from the lower end of the chute 73. The chute 73 has a predetermined width sufficient to allow a large number of targets 90 to fall all at once. A conveyor may be employed as the conveyance part instead of the chute 73.

The optical detection part 20 irradiates the target 90 that has slid down from the chute 73 (i.e., the target 90 falling from the chute 73) with light, and detects light associated with the target 90 (more specifically, transmitted light transmitted through the target 90 and/or reflected light reflected on the target 90). In an alternative embodiment, the target 90 may be irradiated with the light while sliding on the chute 73. Alternatively, in the case where the conveyor is employed instead of the chute 73, the target 90 may be irradiated with the light while being conveyed on the conveyor or falling from the conveyor.

As illustrated in FIG. 1, the optical detection part 20 includes a first light source 31, a second light source 32, a first line sensor 40, and a second line sensor 50. The first light source 31 and the first line sensor 40 are disposed on one side (also referred to as a front side) with respect to a conveyance route of the target 90 (i.e., a falling trajectory from the chute 73). On the other hand, the second light source 32 and the second line sensor 50 are disposed on the other side (also referred to as a rear side) with respect to the conveyance route of the target 90.

The first light source 31 emits first light 33 toward a plurality of targets 90 that is being conveyed (i.e., falling from the chute 73). Similarly, the second light source 32 emits second light 34 toward the plurality of targets 90 that is being conveyed. Each of the first light 33 and the second light 34 has a wavelength corresponding to red, a wavelength corresponding to green, and a wavelength corresponding to blue. In the present embodiment, the first light source 31 and the second light source 32 are so-called color LEDs. However, the light sources 31 and 32 may be any other light-emitting elements (for example, halogen lamps). Further, FIG. 1 illustrates the light sources 31 and 32 assuming that the number of light sources is one for each of them, but the number of light sources may be plural with respect to at least one of the light sources 31 and 32.

The first line sensor 40 and the second line sensor 50 detect the light associated with the target 90 that is being conveyed. The first line sensor 40 on the front side can detect the light 33 emitted from the first light source 31 on the front side and reflected on the target 90 (hereinafter also referred to as the reflected light 33) and the light 34 emitted from the second light source 32 on the rear side and transmitted through the target 90 (hereinafter also referred to as the transmitted light 34). The second line sensor 50 on the rear side can detect the light 34 emitted from the second light source 32 on the rear side and reflected on the target 90 (hereinafter also referred to as the reflected light 34) and the light 33 emitted from the light source 31 on the front side and transmitted through the target 90 (hereinafter also referred to as the transmitted light 33).

What kind of light is detected by the line sensors 40 and 50 is determined based on lighting patterns of the light sources 31 and 32. In a first lighting pattern where the first light source 31 and the second light source 32 are on at the same time, the first line sensor 40 detects light generated by combining the reflected light 33 and the transmitted light 34 (hereinafter also referred to as reflected and transmitted light), and the second line sensor 50 detects reflected and transmitted light generated by combining the reflected light 34 and the transmitted light 33. In a second lighting pattern where the first light source 31 is on and the second light source 32 is off, the first line sensor 40 detects the reflected light 33 and the second line sensor 50 detects the transmitted light 33. In a third lighting pattern where the first light source 31 is off and the second light source 32 is on, the first line sensor 40 detects the transmitted light 34 and the second line sensor 50 detects the reflected light 34. Which pattern is employed, the first lighting pattern, the second lighting pattern, or the third lighting pattern can be determined in any manner according to the kind and properties of the target 90, and the type of the defective product required to be removed. Only any one of the first to third lighting patterns may be employed. Alternatively, two or more lighting patterns out of the first to third lighting patterns may occur alternately at predetermined time intervals or according to a predetermined repetition rule.

In the present embodiment, the line sensors 40 and 50 are color CCD sensors. More specifically, each of the line sensors 40 and 50 includes a plurality of optical elements for detecting light having a wavelength corresponding to red (hereinafter referred to as R elements), a plurality of optical elements for detecting light having a wavelength corresponding to green (hereinafter referred to as G elements), and a plurality of optical elements for detecting light having a wavelength corresponding to blue (hereinafter referred to as B elements). R, G, and B indicate R, G, and B in the RGB color space, respectively. Each of these optical elements includes a collective lens, a color filter, and a photoelectric conversion element. Each of the color filters has a characteristic of permitting transmission of light having a wavelength corresponding to the color of the light that should be detected (for example, red for the R element), and prohibiting transmission of light having the other wavelengths. The line sensors 40 and 50 are not limited to CCD sensors, and may be another type of line sensors such as CMOS sensors.

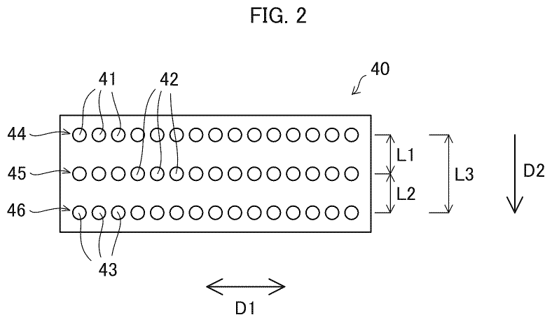

FIG. 2 is a schematic view illustrating the layout of the optical elements in the first line sensor 40. As illustrated, the first line sensor 40 is a so-called three-line sensor, and includes an R element group 44, in which a plurality of R elements 41 is arranged in one row, a G element group 45, in which a plurality of G elements 42 is arranged in one row, and a B element group 46, in which a plurality of B elements 43 is arranged in one row. All the plurality of R elements 41, the plurality of G elements 42, and the plurality of B elements 43 are each arranged linearly in a first direction D1 (this is also a width direction of the chute 73) intersecting with a conveyance direction of the target 90 (a direction in which the target 90 falls). In other words, the R element group 44, the G element group 45, and the B element group 46 are arranged in parallel so as to be spaced apart from each other in a second direction D2 orthogonal to the first direction D1. The second direction D2 is also a direction intended as the conveyance direction of the target 90. However, in practice, the target 90 may have a velocity component in the first direction D1 due to, for example, a collision between targets 90, and, in this case, the conveyance direction of the target 90 extends in a direction intersecting with the second direction D2.

A separation distance between the R element group 44 and the G element group 45 is L1, a separation distance between the G element group 45 and the B element group 46 is L2, and a separation distance between the R element group 44 and the B element group 46 is L3 (=L1+L2). Normally, L1 and L2 are L1=L2 but may be different values. The second line sensor 50 has the same configuration as the first line sensor 40, and therefore the description thereof will be omitted herein.

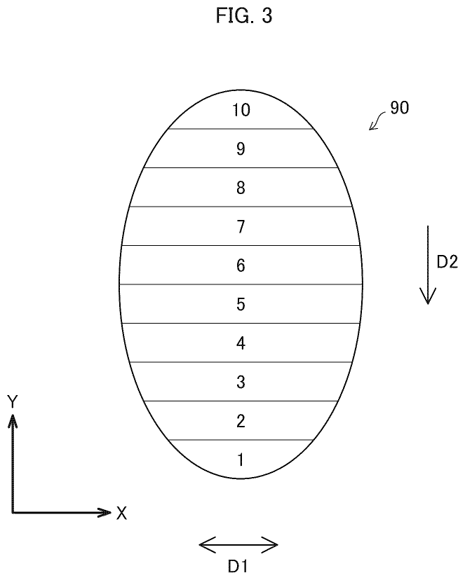

An output from the thus-configured line sensors 40 and 50, i.e., an analog signal indicating a detected light intensity is converted into a digital signal by an AC/DC converter (not illustrated). This digital signal is input to the controller 80 as image data. As widely known, line sensors can acquire a linear image by scanning a target once. Therefore, an image having a predetermined height in a direction corresponding to the second direction D2 (an image sized to contain at least one target 90, and, typically, an image sized to contain a large number of targets 90) can be acquired by combining a plurality of linear images acquired by scanning the target 90 a plurality of times. For example, as illustrated in FIG. 3, an image of one entire target 90 is acquired for each of R, G, and B colors by scanning the target 90 ten times (citing an example, supposing that the target 90 is scanned a smaller number of times than reality for simplification of the description). Numbers 1 to 10 illustrated in FIG. 3 indicate what number scan results in imaging of a linear region labeled this number. For example, image data of a region labeled “2” is acquired by the second scan.

The controller 80 determines a feature of the target 90 with respect to each target 90 as the processing by the feature determination part 82 based on the image acquired by each of the line sensors 40 and 50 in this manner. Such processing is performed for both the image acquired by the first line sensor 40 and the image acquired by the second line sensor 50. In the present embodiment, this feature includes a color feature (i.e., an optical feature), and a feature about shape and/or dimension. Further, the feature includes a feature quantity indicating the feature as a physical quantity and a quality determined based on the feature quantity.

The color feature quantity includes a color tone value of each pixel in the image indicating the target 90. The feature quantity about shape and/or dimension can include, for example, at least one of an area, a height, a width, a perimeter length, and a degree of circularity of a whole and/or part of the target 90. Such a feature quantity may be calculated as a value in units of the number of pixels forming the image. Alternatively, the feature quantity may be calculated as a value expressed in an actual dimension based on the value in units of the number of pixels and the resolution of the line sensor 40 or 50.

In the present embodiment, the “quality” includes, for example, the classification between the acceptable product (i.e., a relatively high-quality rice grain) and the defective product (i.e., a relatively low-quality rice grain and/or a foreign object). However, the “quality” may include the type of the defect (for example, into which the defect is classified, broken rice, an immature grain, a colored grain, a damaged grain, dead rice, or a foreign object). Alternatively, the “quality” may include a classification between an object that should be removed and an object that should not be removed by the sorting part 60. Further, the “quality” includes a quality determined based on the color feature. A defective product determined based on the color feature can include, for example, an immature grain, a colored grain, a damaged grain, dead rice, and a foreign object. A defective product determined based on the feature about shape and/or dimension can include, for example, broken rice, a bug-damaged grain, and a foreign object.

In the present embodiment, the feature determination part 82 determines whether the target 90 is the acceptable product or the defective product by comparing the color feature quantity (i.e., the tone value of the image data) and a predetermined threshold value (i.e., based on whether the color feature quantity falls within a predetermined normal range). Such a determination may be made based on a representative value (a mean, a median, a maximum, a minimum, or the like) of tone values of a plurality of pixels forming the image of the target 90. Alternatively, the defective product may include a target 90 having a partial defect equal to or larger than a predetermined size. Such a partial defect may be determined based on the fact that the number of pixels having tone values outside the normal range among the plurality of pixels forming the image of the target 90 is equal to or larger than a predetermined value (i.e., the fact that the area of the defective portion is a predetermined value or larger).

Further, in the present embodiment, the feature determination part 82 determines whether the target 90 is the acceptable product or the defective product by comparing the feature quantity about shape and/or dimension and a predetermined threshold value (i.e., based on whether the feature quantity about shape and/or dimension falls within a predetermined normal range).

The sorting part 60 sorts the target 90 based on the feature determined by the feature determination part 82. The target 90 is sorted by a trajectory change operation for changing the trajectory of the specific target 90. More specifically, the sorting part 60 includes a plurality of nozzles 61 and as many valves 62 as a number corresponding to the nozzles 61 (the number of valves 62 is equal to the number of nozzles 61 in the present embodiment, but may be different from the number of nozzles 61). The plurality of nozzles 61 is arrayed in the width direction of the chute 73.

The plurality of nozzles 61 is connected to a compressor (not illustrated) respectively via the plurality of valves 62. The plurality of valves 62 are selectively opened in response to a control signal from the controller 80, by which the plurality of nozzles 61 selectively eject air 63 toward the target 90 determined to be the defective product (more precisely, the target 90 determined to be the defective product based on the color feature quantity and the target 90 determined to be the defective product based on the feature quantity about shape and/or dimension with respect to the image acquired by at least one of the line sensors 40 and 50). The target 90 determined to be the defective product is blown off by the air 63, and is deviated from the falling trajectory from the chute 73 and guided to the defective product discharge gutter 75 (illustrated as a target 91 in FIG. 1). On the other hand, the air 63 is not ejected toward the target 90 determined to be the acceptable product. Therefore, the target 90 determined to be the acceptable product is guided to the acceptable product discharge gutter 74 without changing the falling trajectory thereof (illustrated as a target 92 in FIG. 1).

In an alternative embodiment, the conveyance route of the target 90 may be changed by ejecting the air 63 toward the target 90 that is sliding on the chute 73, instead of the configuration that ejects the air 63 toward the target 90 after the target 90 falls from the chute 73. Further, a belt conveyor may be employed as the conveyance means instead of the chute 73. In this case, the air may be ejected toward the target that falls from one end of the belt conveyor. Alternatively, the air may be ejected toward the target that is being conveyed on the belt conveyor.

In a further alternative embodiment, the air 63 may be ejected toward the target 90 determined to be the acceptable product (so-called reverse screening) instead of the configuration that ejects the air 63 toward the target 90 determined to be the defective product. Further, the trajectory change operation is not limited to the ejection of the air 63, and may be realized by employing any other known method.

The above-described sorter 10 detects a conveyance velocity in a predetermined direction with respect to the target 90 that is being convened, and determines the feature about shape and/or dimension based on this conveyance velocity, with the aim of improving the accuracy regarding the determination on the feature about shape and/or dimension of the target 90. In the following description, such a configuration will be described in detail. In the present embodiment, the predetermined direction includes both the first direction D1 and the second direction D2. However, the predetermined direction may be only one of the first direction D1 and the second direction D2.

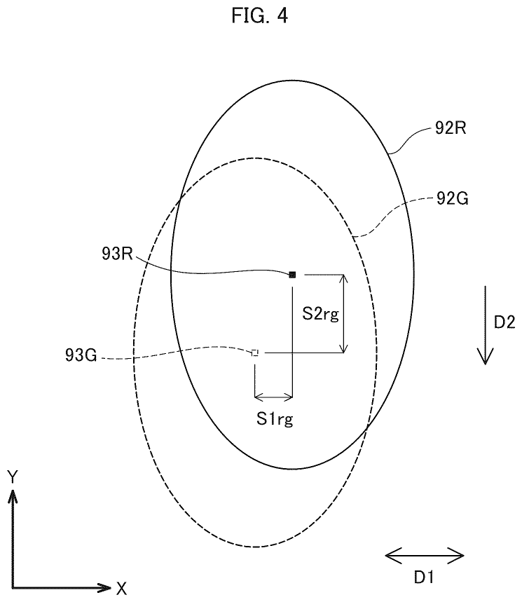

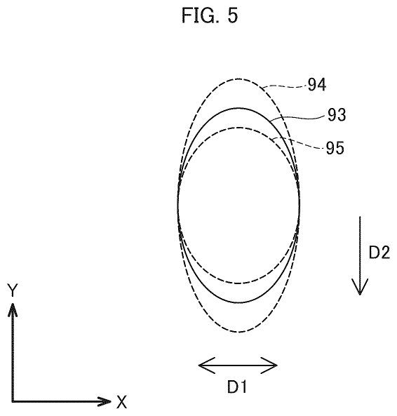

First, a method for detecting the conveyance velocity of the target 90 in the predetermined direction will be described with reference to FIGS. 4 and 5. This method will be described now, citing the details of a method for detecting, using the first line sensor 40, the conveyance velocity that the target 90 has at the moment that the target 90 is imaged by the first line sensor 40. Such detection of the conveyance velocity is performed as processing by the conveyance velocity calculation part 81 of the controller 80.

To detect the conveyance velocity, first, the conveyance velocity calculation part 81 calculates a color shift amount with respect to the color image acquired by the first line sensor 40. In the first line sensor 40, the R element group 44, the G element group 45, and the B element group 46 scan the target 90 at the same time. However, since the R element group 44, the G element group 45, and the B element group 46 are spaced apart from each other in the second direction D2 (refer to FIG. 2), strictly speaking, the imaged portion of the target 90 is shifted between these colors by an amount corresponding to this separation distance. Therefore, a color shift occurs in the direction corresponding to the second direction D2 between the red image acquired by the R element group 44, the green image acquired by the G element group 45, and the blue image acquired by the B element group 46. Further, if the conveyance direction of the target 90 contains a component in the first direction D1 (i.e., if the conveyance direction of the target 90 is a direction intersecting with the second direction D2 (except for the vertical direction)) due to, for example, a collision between targets 90, this leads to additional occurrence of a color shift in a direction corresponding to the first direction D1 between the red image, the green image, and the blue image. The amount of such a color shift is calculated in units smaller than one pixel, which is the unit forming the image.

In the present embodiment, the conveyance velocity calculation part 81 calculates color shift amounts S1rg and S2rg between the red image and the green image, color shift amounts S1gb and S2gb between the green image and the blue image, and color shift amounts S1rb and S2rb between the red image and the blue image. FIG. 4 illustrates one example of a method for calculating the color shift amounts. This example will be described now with reference to FIG. 4, assuming that the color shift amounts S1rg and S2rg between a red image 92R and a green image 92G are calculated for each grain of the target 90. In the calculation of the color shift amount, the conveyance velocity calculation part 81 first sets common coordinates at a resolution finer than one pixel with respect to each of the red image 92R of one grain of the target 90 and the green image 92G of this one grain of the target 90. For example, coordinate points may be set in units of 1/1000 pixels with respect to each of an X direction (the direction corresponding to the first direction D1) and a Y direction (the direction corresponding to the second direction D2). In this case, a million (=1000×1000) coordinate points are allocated to one pixel. This resolution can be set to any value according to the desired accuracy of calculating the color shift amount.

Next, the conveyance velocity calculation part 81 calculates a red density centroid coordinate point 93R of the red image 92R and a green density centroid coordinate point 93G of the green image 92G based on a color tone value of each coordinate point (the tone values of a million coordinate points corresponding to one pixel are the same as one another). The coordinate value of the density centroid coordinate point can be calculated by dividing a sum of values each resulting from multiplying the coordinate value by the tone value for each coordinate point by a sum of the respective tone values of the coordinate points, with respect to each of the X coordinate and the Y coordinate.

Then, the conveyance velocity calculation part 81 calculates the color shift amount based on the calculated density centroid coordinate point. For example, as illustrated in FIG. 4, the conveyance velocity calculation part 81 acquires a separation distance between the red density centroid coordinate point 93R and the green density centroid coordinate point 93G in the Y direction (i.e., the direction corresponding to the second direction D2) as the color shift amount S2rg (in units of pixels) in the Y direction between the red image 92R and the green image 92G. Further, the conveyance velocity calculation part 81 acquires a separation distance between the red density centroid coordinate point 93R and the green density centroid coordinate point 93G in the X direction (i.e., the direction corresponding to the first direction D1) as the color shift amount S1rg in the X direction between the red image 92R and the green image 92G. Similarly, the conveyance velocity calculation part 81 calculates each of the color shift amounts S2gb and S1gb in the Y direction and the X direction between the green image 92G and the blue image 92B and the color shift amounts S2rb and S1rb in the Y direction and the X direction between the red image 92R and the blue image 92B.

The calculation of the color shift amount is not limited to the above-described method using the density centroid, and can be made using any known method. The color shift amount may be calculated for each group of grains overlapping each other in the color image instead of or in addition to the configuration that calculates the color shift amount for each grain of the target 90. An image region (hereinafter also referred to as a blank region) other than the image region indicating a grain of the target 90 or a grain group may be excluded from regions targeted for the calculation of the color shift amount to calculate the color shift amount for each grain of the target 90 and/or for each grain group. The blank region can be easily removed by binarizing the color image. Calculating the color shift amount grain by grain or grain group by grain group in this manner allows the color shift amount to be accurately calculated. However, the conveyance velocity calculation part 81 may divide the color region into a plurality of regions (these regions are each sized to allow a plurality of grains to be contained therein) and calculate the color shift amount for each of the plurality of regions.

Next, the conveyance velocity calculation part 81 calculates the conveyance velocity of the target 90 in the second direction D2 based on the color shift amounts S2rg, S2gb, and S2rb in the Y direction (i.e., the direction corresponding to the second direction D2) for each grain of the target 90. When a scan time T is defined to be a time required for the first line sensor 40 to scan the target 90 once, a conveyance velocity V2rg of the target 90 in the second direction D2 that is calculated based on the color shift amount S2rg between the red image 92R and the green image 92G can be acquired by, for example, the following equation (1). In the equation (1), L1 is L1>0. Further, in the equation (1), the unit of the color shift amount S2rg is a unit indicating the distance. For example, the units of the separation distance L1 and the color shift amount S2rg are “mm” and the unit of the scan time T is “ms”, and the conveyance velocity V2rg in units of “m/s” is acquired in this case. In the case where the conveyance velocity calculation part 81 acquires the color shift amount S2rg in units of “pixels” in the above-described manner, the color shift amount S2rg in units of “mm” can be acquired by multiplying the color shift amount S2rg in units of “pixels” by the pixel size (mm) (i.e., the size per pixel) of the first line sensor 40 in the second direction D2. The conveyance velocity V2rg is not limited to being calculated using the equation (1), and may be calculated by another equation including the color shift amount S2rg as a variable based on an experiment or the like.

$$V 2 rg = ( L 1 + S 2 rg ) / T \qquad ( 1 )$$

Similarly, a conveyance velocity V2gb of the target 90 in the second direction D2 that is calculated based on the color shift amount S2gb can be acquired by the following equation (2), and a conveyance velocity V2rb of the target 90 in the second direction D2 that is calculated based on the color shift amount S2rb can be acquired by the following equation (3). In the equation (2) and the equation (3), L2 and L3 are L2>0 and L3>0.

$$V 2 gb = ( L 2 + S 2 gb ) / T \qquad ( 2 )$$

$$V 2 rb = ( L 3 + S 2 rb ) / T \qquad ( 3 )$$

Further, the conveyance velocity calculation part 81 respectively calculates conveyance velocities V1rg, V1gb, and V1rb of the target 90 in the first direction D1 based on the color shift amounts S1rg, S1gb, and S1rb in the X direction (i.e., the direction corresponding to the first direction D1). The conveyance velocities V1rg, V1gb, and V1rb can be acquired by, for example, the following equations (4) to (6), respectively.

$$V 1 rg = S 1 rg / T \qquad ( 4 )$$

$$V 1 gb = S 1 gb / T \qquad ( 5 )$$

$$V 1 rb = S 1 rb / T \qquad ( 6 )$$

The conveyance velocity calculation part 81 detects a representative value of the thus-acquired conveyance velocities V2rg, V2gb, and V2rb (for example, a mean or a median thereof) as a conveyance velocity V2 of the target 90 in the second direction D2. Similarly, the conveyance velocity calculation part 81 detects a representative value of the conveyance velocities V1rg, V1gb, and V1rb (for example, a mean or a median thereof) as a conveyance velocity V1 of the target 90 in the first direction D1. In an alternative embodiment, the conveyance velocity calculation part 81 may detect the conveyance velocity V2 based on one or two of the conveyance velocities V2rg, V2gb, and V2rb, and/or may detect the conveyance velocity V1 based on one or two of the conveyance velocities V1rg, V1gb, and V1rb.

Next, a method for determining the feature about shape and/or dimension of the target 90 based on the conveyance velocity will be described with reference to FIGS. 5 to 7. This method will be described now, citing the details of a method for determining the feature about shape and/or dimension of the image acquired by the first line sensor 40 based on the conveyance velocity calculated based on the image acquired by the first line sensor 40. In the present embodiment, the feature determination part 82 corrects the image of the target 90 based on the conveyance velocity V1 in the first direction D1 and the conveyance velocity V2 in the second direction D2, and determines the feature about shape and/or dimension of the target 90 based on the corrected image. However, the image of the target 90 may be subjected to only one of the correction based on the conveyance velocity V1 and the correction based on the conveyance velocity V2. The image is corrected based on the conveyance velocity V1 and/or the conveyance velocity V2 for each grain of the target 90.

First, the correction of the image based on the conveyance velocity V2 in the second direction D2 will be described. The resolution of the line sensor in the second direction D2 (a direction orthogonal to the direction in which each of the elements 41 to 43 is lined up in the example illustrated in FIG. 2) is determined based on the distance by which the target 90 moves in the second direction D2 during one scan time. More specifically, the resolution in the second direction D2 is expressed as a product of one scan time and the conveyance velocity V2 of the target 90 in the second direction D2. This means that the size (i.e., the number of pixels) of the target 90 in the direction corresponding to the second direction D2 (i.e., the Y direction in FIG. 4) in the image varies depending on the conveyance velocity V2. More specifically, the conveyance velocity V2 of the target 90 in the second direction D2 and the size of the target 90 in the direction corresponding to the second direction D2 in the image are in an inverse proportion relationship. On the other hand, the resolution of the line sensor in the first direction D1 is constant independently of the conveyance velocity of the target 90.

The line sensor having such a characteristic leads to a difference made between the size of the target 90 in the direction corresponding to the second direction D2 in the image and the actual size when the target 90 is conveyed at the conveyance velocity V2 different from a conveyance velocity expected in advance (i.e., a design value regarding the conveyance velocity V2). In such a case, the feature quantity about shape and/or dimension is measured with low accuracy. Further, the threshold value for determining the quality about shape and/or dimension is preset based on the design value regarding the conveyance velocity V2 (i.e., based on the actual size of the target 90). Therefore, the quality about shape and/or dimension is also measured with low accuracy when the target 90 is conveyed at the conveyance velocity V2 different from the conveyance velocity expected in advance. To prevent or lessen such a reduction in the measurement accuracy, the image acquired by the first line sensor 40 is corrected based on the conveyance velocity V2 in the second direction D2 in the present embodiment.

More specifically, the feature determination part 82 corrects the size of the target 90 in the second direction D2 in the image acquired by the first line sensor 40 in a direction for reducing or removing the influence exerted on the image (more specifically, the size of the image of the target 90 in the direction corresponding to the second direction D2) by the difference between the conveyance velocity V2 in the second direction D2 that is calculated by the conveyance velocity calculation part 81 and the design value regarding the conveyance velocity V2 in the second direction D2 (hereinafter also referred to as a reference value VR).

For example, if the conveyance velocity V2 in the second direction D2 that is calculated by the conveyance velocity calculation part 81 is higher than the reference value VR, the target 90 appears in a smaller size in the direction corresponding to the second direction D2 in the image than the actual size. In such a case, the feature determination part 82 corrects the image so as to enlarge the size of the target 90 in the direction corresponding to the second direction D2 in the image to reduce or remove the influence thereof.

Conversely, if the conveyance velocity V2 in the second direction D2 that is calculated by the conveyance velocity calculation part 81 is lower than the reference value VR, the target 90 appears in a larger size in the direction corresponding to the second direction D2 in the image than the actual size. In such a case, the feature determination part 82 corrects the image so as to reduce the size of the target 90 in the direction corresponding to the second direction D2 in the image to reduce or remove the influence thereof.

Since the actual conveyance velocity V2 of the target 90 in the second direction D2 and the size of the target 90 in the direction corresponding to the second direction D2 in the image are in an inverse proportion relationship as described above, the influence on the image due to the fluctuation of the conveyance velocity V2 can be minimized (i.e., the size of the target 90 in the image can be corrected into the actual size) by making a correction of multiplying the dimension (i.e., the number of pixels) of the image of the target 90 acquired by the first line sensor 40 in the direction corresponding to the second direction D2 by a ratio of V2/VR. FIG. 5 illustrates one example of such a correction. If the conveyance velocity V2 is lower than the reference value VR, a target 94 (the image of the target 90 before the correction) is reduced in size only in the Y direction corresponding to the second direction D2 at the ratio of V2/VR, and a target 93 (the image of the target 90 in the actual size) is acquired as a result. On the other hand, if the conveyance velocity V2 is higher than the reference value VR, a target 95 (the image of the target 90 before the correction) is enlarged in size only in the Y direction corresponding to the second direction D2 at the ratio of V2/VR, and the target 93 (the image of the target 90 in the actual size) is acquired as a result.

The feature determination part 82 determines the feature about shape and/or dimension of the target 90 (i.e., the feature quantity and the quality based thereon) based on the image corrected based on the conveyance velocity V2 in this manner. According to such a correction, even when the resolution of the line sensor 40 in the second direction D2 varies due to a fluctuation of the conveyance velocity V2 and the acquired image of the target 90 has a size different from the actual size in the direction corresponding to the second direction D2, this image can be corrected so as to have a size closer to or the same as the actual size in the second direction D2. Therefore, the feature determination part 82 can accurately determine the feature about shape and/or dimension of the target 90 based on the corrected image.

Next, the correction of the image based on the conveyance velocity V1 in the first direction D1 will be described. If the target 90 has a velocity component in the first direction D1, simply combining each scanned image results in an accidental stepwise shift of the linear regions numbered with 1 to 10 illustrated in FIG. 3 in the direction corresponding to the first direction D1. Therefore, the detected shape is distorted in the direction corresponding to the first direction D1 (the Y direction) compared with the actual shape of the target 90, which leads to a reduction in the accuracy of measuring the feature about shape and/or dimension of the target 90 as a result. In light thereof, the image is corrected based on the conveyance velocity V1 in the first direction D1 to prevent or lessen such a reduction in the measurement accuracy in the present embodiment.

More specifically, the feature determination part 82 corrects the coordinate values in the first direction D1 of the plurality of pixels forming the image of the target 90 by an amount corresponding to the shift caused by the conveyance velocity V1 in the first direction D1. More specifically, the coordinate values of the target 90 in the first direction D1 are shifted between an image region of the target 90 acquired by an N-th scan (N is a natural number) and an image region of the target 90 acquired by an N+1-th scan by a distance L4 by which the target 90 moves in the first direction D1 during one scan time of the first line sensor 40. In light thereof, the feature determination part 82 sets the first scan conducted on one target 90 as a reference and corrects the coordinate values of the images of the target 90 acquired by a second or later scan so as to return them to the original position by a distance corresponding to the shift from the reference. The correction amount (the actual distance) of the coordinate values of the image region of the target 90 acquired by an M-th scan (M is an integer equal to or greater than 2) is expressed as (M−1)×L4. The correction amount in units of the number of pixels can be calculated by dividing the value of (M−1)×L4 by the size of a pixel of the first line sensor 40 in the first direction D1 (i.e., the size per pixel).

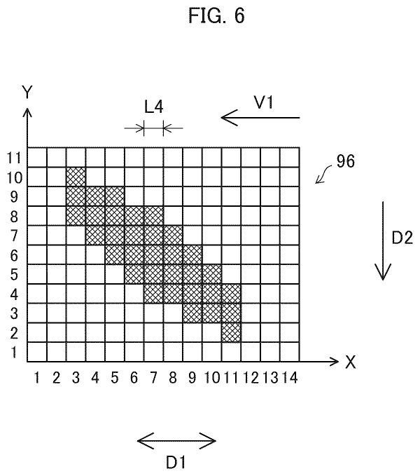

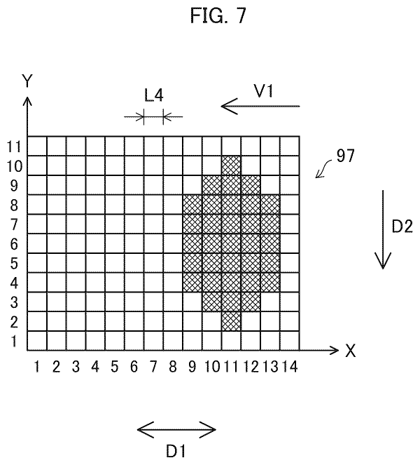

FIGS. 6 and 7 illustrate one example of such a correction. Each cell in the drawings represents one pixel forming the image. Further, numerical values in the drawings represent coordinate values in an XY coordinate system defined by the X direction corresponding to the first direction D1 and the Y direction corresponding to the second direction D2. In this example, a coordinate value in the Y direction is assigned to each scan of the first line sensor 40. In other words, the Y coordinate value indicates what number scan results in the acquisition of the corresponding linear image. Hatched cells in FIG. 6 represent the pixels indicating the target 90 in the image before the correction (illustrated as a target 96), and hatched cells in FIG. 7 represent the pixels indicating the target 90 in the image after the correction (illustrated as a target 97).

Further, FIGS. 6 and 7 illustrate an example supposing that the direction of the conveyance velocity V1 is a direction toward a negative direction of the X coordinate, and the distance L4 (the distance by which the target 90 moves in the first direction D1 during one scan time) is equal to the resolution of the line sensor 40 in the first direction D1. As illustrated, the image of the target 96 illustrated in FIG. 6 (the image of the target 90 imaged into a distorted shape due to the conveyance velocity V1 in the first direction D1) is corrected in such a manner that the X coordinate value is increased by the distance L4 in terms of the X coordinates (the distance corresponding to one pixel in this example) as the Y coordinate value is incremented by one based on the line along which the Y coordinate value is 2, and is thereby corrected into the image of the target 97 illustrated in FIG. 7 (the image of the target 90 in the actual shape).

The feature determination part 82 determines the feature about shape and/or dimension of the target 90 based on the image corrected based on the conveyance velocity V1 in this manner. According to such a correction, even when the target 90 is conveyed while deviating sideways from the intended conveyance direction (i.e., the second direction D2) (i.e., while deviating in the first direction D1) and the acquired image of the target 90 is distorted in the direction corresponding to the first direction D1, the image can be corrected so as to reduce or remove this distortion. Therefore, the feature determination part 82 can accurately determine the feature about shape and/or dimension of the target 90 based on the corrected image.

The conveyance velocity calculation part 81 may calculate the conveyance velocity V1 and/or the conveyance velocity V2 based on the color shift amount of the image acquired by the second line sensor 50. In this case, the feature determination part 82 may correct the image acquired by the second line sensor 50 based on the conveyance velocity V1 and/or the conveyance velocity V2 acquired using the second line sensor 50, and determine the feature about shape and/or dimension of the target 90 based on the corrected image.

In the present embodiment, the conveyance velocity calculation part 81 corrects the image of the corresponding target 90 based on the conveyance velocity V1 and/or the conveyance velocity V2 calculated for each target 90. In other words, the conveyance velocity V1 and/or the conveyance velocity V2 used in the correction is/are a value/values specific to each individual target 90. According to this configuration, the conveyance velocity calculation part 81 can make a further accurate correction using the further accurate conveyance velocity V1 and/or the further accurate conveyance velocity V2 for each individual target 90. As a result, the feature about shape and/or dimension can be further accurately determined. However, the conveyance velocity V1 and/or the conveyance velocity V2 detected at a predetermined timing with respect to at least one target 90 may be used in common to correct a plurality of images of targets 90. In this case, the conveyance velocity V1 and/or the conveyance velocity V2 used for the correction may be updated with predetermined frequency (for example, every five minutes). Alternatively, the conveyance velocity V1 and/or the conveyance velocity V2 detected when the operation of the sorter 10 is started may be continuously used for the correction in the operation after the detection. According to these configurations, the calculation load on the conveyance velocity calculation part 81 can be reduced. Further, a representative value regarding a plurality of targets 90 (for example, a mean) may be used in common to correct the images of this plurality of targets 90 as the conveyance velocity V1 and/or the conveyance velocity V2.

In an alternative embodiment, the feature determination part 82 may directly correct the feature quantity about shape and/or dimension based on the conveyance velocity V2 in the second direction D2 instead of the configuration that corrects the image based on the conveyance velocity V2 in the second direction D2. In this alternative embodiment, to acquire a feature quantity (also referred to as a first feature quantity) corresponding to the feature quantity about shape and/or dimension determined based on the corrected image, the feature determination part 82 first determines the feature quantity about shape and/or dimension (a second feature quantity) based on the image (the image not subjected to the above-described correction) acquired by the first line sensor 40 (or the second line sensor 50). Next, the feature determination part 82 corrects the second feature quantity by correcting, based on the conveyance velocity V2 in the second direction D2, a feature quantity component in the direction corresponding to the second direction D2 that is contained in the second feature quantity, thereby acquiring the first feature quantity.

For example, if the feature quantity that should be acquired as the first feature quantity is the area or the height (the length in the direction corresponding to the second direction D2) of the target 90, the feature determination part 82 specifies a value acquired by multiplying the second feature quantity by the ratio of V2/VR as the first feature quantity. If the feature quantity that should be acquired as the first feature quantity is the width (the length in the direction corresponding to the first direction D1) of the target 90, the feature determination part 82 specifies the second feature quantity as the first feature quantity without making a correction. If the feature quantity that should be acquired as the first feature quantity is the perimeter length of the target 90, the feature determination part 82 corrects only a length component in the direction corresponding to the second direction D2 (also referred to as Ly) that is contained in the perimeter length by multiplying the length component by the ratio of V2/VR without correcting a length component in the direction corresponding to the first direction D1 (also referred to as Lx) that is contained in the perimeter length, and specifies a value of Lx+Ly×V2/VR as the first feature quantity.

The components Lx and Ly can be identified using, for example, a method discussed in Japanese Patent Application Laid-Open No. 2012-127706. This method is known, and therefore will be briefly described. First, the image is binarized and the pixel range indicating the target 90 is identified. Next, a window having a predetermined size (for example, 2×2 pixels or 3×3 pixels) is applied to the pixel range indicating the target 90. Whether a pixel located in the window is a pixel indicating the periphery of the target 90 or a pixel indicating the inside of the target 90 can be identified, and whether the pixel indicating the periphery of the target 90 corresponds to the component Lx or the component Ly can also be identified according to at which position the pixel indicating the target 90 is located in the window. Such identification processing is repeated while the position to which the window is applied is shifted pixel by pixel with respect to all of the pixels indicating the target 90 until the attributes thereof are identified.

After acquiring the first feature quantity about shape and/or dimension in this manner, the feature determination part 82 determines the quality about shape and/or dimension by the above-described method based on the first feature quantity. An advantageous effect equivalent to when the image is corrected can also be achieved by correcting the second feature quantity based on the conveyance velocity V2 to acquire the first feature quantity instead of correcting the image based on the conveyance velocity V2 in the above-described manner.

In a further alternative embodiment, the feature determination part 82 may determine (correct) the threshold value for determining the quality about shape and/or dimension based on the conveyance velocity V2 in the second direction D2 instead of the configuration that corrects the image based on the conveyance velocity V2 in the second direction D2. As described above, the size of the target 90 in the direction corresponding to the second direction D2 in the image is VR/V2 times as large as the actual size. In light thereof, the feature determination part 82 corrects the threshold value by, for example, multiplying the design value of the threshold value relating to the direction corresponding to the second direction D2 by the ratio of VR/V2. In other words, the feature determination part 82 corrects the threshold value in such a manner that the threshold value changes at an equivalent rate according to a change in the image dimension in the second direction D2 due to a fluctuation of the conveyance velocity V2.

For example, the feature determination part 82 may correct the threshold value relating to the area or the height (the length in the direction corresponding to the second direction D2) of the target 90 by multiplying the threshold value by the ratio of VR/V2. In this case, the feature determination part 82 determines whether the target 90 is the acceptable product or the defective product by comparing the feature quantity about shape and/or dimension calculated from the uncorrected image and the corrected threshold value. According to such a configuration, the quality about shape and/or dimension of the target 90 can also be accurately determined.

In a further alternative embodiment, the conveyance velocity V1 and/or the conveyance velocity V2 may be detected by any method different from the above-described methods. For example, the sorter 10 may include an area sensor for detecting the conveyance velocity V1 and/or the conveyance velocity V2. In this case, the feature determination part 82 calculates the conveyance velocity V1 and/or the conveyance velocity V2 with respect to the same target 90 in two images acquired at two different timings by the area sensor based on a movement distance and a movement time between these two timings. The movement distance may be calculated based on a difference between the positions of the respective density centroids of the target 90 in the two images similarly to the above-described example. The movement time can be calculated based on the known scan time. Alternatively, the sorter 10 may use two line sensors respectively disposed at different detection positions (positions in the conveyance route where the target 90 is imaged), instead of such an area sensor.

Having described embodiments, the above-described embodiments are intended to only facilitate the understanding of the present teachings, and are not intended to limit the present invention thereto. The present invention can be modified or improved without departing from the spirit thereof, and the present invention includes equivalents thereof. Further, each of the elements described in the claims and the specification can be combined in any manner or omitted in any manner within a range that allows it to remain capable of solving at least a part of the above-described problems or bringing about at least a part of the above-described advantageous effects.

For example, the line sensors 40 and 50 may be any color sensors in which at least two element groups out of the R element group, the G element group, and the B element group are arranged so as to be spaced apart from each other in the second direction D2 instead of the above-described three-line sensors. For example, the line sensors 40 and 50 may be color sensors having a Bayer arrangement. In this case, the conveyance velocity V1 and/or the conveyance velocity V2 can be determined based on the color shift amount between the red image and the blue image acquired from the R element group and the B element group.

Alternatively, the feature determination part 82 may determine the feature about shape and/or dimension with respect to a part of the target 90 based on the conveyance velocity V1 and/or the conveyance velocity V2. Such a part of the target 90 may be a portion of the target 90 that has a predetermined color feature. For example, the feature determination part 82 may determine the feature quantity about shape and/or dimension of a region having a partial defect (i.e., a region in the image that is formed by a group of pixels whose color tone values fall outside a normal range) based on the conveyance velocity V1 and/or the conveyance velocity V2 for the purpose of determining the color quality of the target 90 based on whether the target 90 has a partial defect equal to or larger than a predetermined size.

Alternatively, the sorter 10 may include an electromagnetic wave irradiation source that irradiates the target 90 with an electromagnetic wave having any wavelength instead of or in addition to the visible light source (the light sources 31 and 32 in the above-described example). Such an electromagnetic wave may be, for example, at least one of an X-ray and near-infrared light. In this case, the sorter 10 may include a line sensor including a plurality of electromagnetic wave detection elements corresponding to the wavelength of the electromagnetic wave emitted from the electromagnetic wave irradiation source. The above-described various corrections are also applicable to an image acquired using such an electromagnetic wave irradiation source and line sensor.

The present invention can be embodied in various forms without being limited to the sorter. For example, the present invention may be embodied as a measurement apparatus for measuring a feature about shape and/or dimension with respect to a whole and/or part of a target. Such a measurement apparatus may have, for example, such a configuration that the sorting part 60 is removed from the sorter 10 illustrated in FIG. 1. In this case, the controller 80 may output the determined feature of the target 90 (or a statistic thereof) to any device (for example, a display, a communication interface, a storage medium, or a printing apparatus).

### DESCRIPTION OF THE REFERENCE NUMERALS

10 optical sorter
20 optical detection part
31 first light source
32 second light source
33 first light
34 second light
40 first line sensor
41 R element
42 G element
43 B element
44 R element group
45 R element group
46 R element group
50 second line sensor
60 sorting part
61 nozzle
62 valve
63 air
71 storage tank
72 feeder
73 chute
74 acceptable product discharge gutter
75 defective product discharge gutter
80 controller
81 conveyance velocity calculation part
82 feature determination part
90, 91, 92, 93, 94, 95, 96, 97 target
92G green image
92R red image
93G green density centroid coordinate point
93R red density centroid coordinate point
D1 first direction
D2 second direction

1. A measurement apparatus for measuring a feature about shape and/or dimension with respect to a whole and/or part of a target, the measurement apparatus comprising:
a conveyance part configured to convey the target;
an electromagnetic wave irradiation source configured to irradiate the target with an electromagnetic wave while the target is conveyed due to an action of the conveyance part;
a line sensor including a plurality of electromagnetic wave detection elements linearly arranged in a first direction intersecting with a conveyance direction of the target, the line sensor being configured to detect at least one of a reflected electromagnetic wave emitted from the electromagnetic wave irradiation source and reflected on the target and a transmitted electromagnetic wave emitted from the electromagnetic wave irradiation source and transmitted through the target; and
a controller,
the controller is configured to:
detect a conveyance velocity in a predetermined direction with respect to the target in transit; and
determine the feature of the target based on an image acquired by the line sensor and the conveyance velocity in the predetermined direction.

2. The measurement apparatus according to claim 1, wherein the feature includes a first feature quantity with respect to the whole and/or part of the target, and
the controller is further configured to correct the image acquired by the line sensor based on the conveyance velocity in the predetermined direction and determine the first feature quantity based on the corrected image, or configured to determine the first feature quantity by correcting, based on the conveyance velocity in the predetermined direction, a second feature quantity which is determined based on the image acquired by the line sensor.

3. The measurement apparatus according to claim 1, wherein the feature includes a quality with respect to the whole and/or part of the target,
the controller is configured to determine the quality based on the first feature quantity with respect to the whole and/or part of the target, and
the controller is further configured to correct the image acquired by the line sensor based on the conveyance velocity in the predetermined direction and acquire the first feature quantity based on the corrected image, or configured to acquire the first feature quantity by correcting, based on the conveyance velocity in the predetermined direction, a second feature quantity which is determined based on the image acquired by the line sensor.

4. The measurement apparatus according to claim 1, wherein the predetermined direction includes a second direction orthogonal to the first direction,
the feature includes a quality with respect to the whole and/or part of the target, and
the controller is further configured to determine the quality by comparing a feature quantity determined based on the image acquired by the line sensor and a threshold value determined based on the conveyance velocity in the second direction.

5. The measurement apparatus according to claim 2, wherein the predetermined direction includes a second direction orthogonal to the first direction, and
the controller is further configured to correct the image by correcting a size of the image in the second direction based on the conveyance velocity in the second direction, or correct the second feature quantity by correcting, based on the conveyance velocity in the second direction, a feature quantity component in the second direction that is contained in the second feature quantity.

6. The measurement apparatus according to claim 1, wherein the predetermined direction includes the first direction, and
the controller is further configured to correct the image by correcting, based on the conveyance velocity in the first direction, coordinate values in the first direction at a plurality of pixels forming the image, and determine the feature of the target based on the corrected image.

7. A sorter comprising:
the measurement apparatus according to claim 1; and
a sorting part configured to sort the target based on the feature determined by the controller.
